(19) United States
(12) Patent Application Publication
(10) Pub. No.: US 2011/0315235 A1
(43) Pub. Date: Dec. 29, 2011

(54) VALVE DEVICE FOR PNEUMATIC TYRE INCLUDING PRESSURE SENSOR

(76) Inventors: Warwick Ian Colefax, New South Wales (AU); Alex Pappas, New South Wales (AU)

(21) Appl. No.: 13/059,581

(22) PCT Filed: Aug. 21, 2009
(86) PCT No.: PCT/AU2009/001082

§ 371 Date: May 2, 2011

(30) Foreign Application Priority Data
Aug. 21, 2008 (AU) 2008904296

(51) Int. Cl. F16K 15/20

(52) U.S. Cl. 137/224

(57) ABSTRACT

A valve device (10) for a pneumatic tyre (12) having an upper and lower desired inflation pressure. The valve device includes a main body (16) having an inlet port (18) adapted for sealed engagement with a compressed air supply (20) and an outlet port (22) adapted for sealed engagement with the pneumatic tyre. At least one pressure sensor (24) for sensing the pressure in the pneumatic tyre and an electrical indicating means operatively associated with the at least one pressure sensor is also provided for indicating to a user when the pressure in the pneumatic tyre is below the lower desired inflation pressure or above the upper desired inflation pressure.

### FIELD OF THE INVENTION

The present invention relates to valve devices and in particular to valve devices for pneumatic tyres.

The invention has been developed primarily for use as a valve device for an automotive pneumatic tyre and will be described hereinafter with reference to this application. However, it will be appreciated that the invention is not limited to this particular field of use.

### BACKGROUND OF THE INVENTION

The following discussion of the prior art is intended to place the invention in an appropriate technical context and enable the associated advantages to be fully understood. However, any discussion of the prior art throughout the specification should not be considered as an admission that such art is widely known or forms part of the common general knowledge in the field.

Pneumatic tyres having the correct inflation pressures are critical to the operation of a motor vehicle. An under inflated tyre may adversely affect the motor vehicle's ability to negotiate corners, whilst also making it unstable at speed. An under inflated tyre will also require more energy to rotate and therefore increase the motor vehicle's fuel consumption. Moreover, it is known that an under inflated tyre has the potential to overheat which can cause failure and potentially put at risk the safety of the occupants of the vehicle. An over inflated tyre on the other hand, may result in premature tyre tread wear and reduced frictional properties especially if the road surface is wet.

It is therefore a vital part of a motor vehicle's maintenance regime to maintain the correct tyre pressures. Whilst most drivers appreciate this need, tyre pressures are typically not maintained due to an inability to accurately use a tyre pressure gauge or an unawareness of the correct inflation pressure required. In addition, it has been found that some service centres have tyre inflation facilities that are defective and pressure gauges that are inaccurate. Furthermore, a tyre that is under inflated by even as much as 50% is not particularly obvious to the untrained eye, and hence often goes unattended.

To further highlight the aforementioned safety concerns, the United States has introduced legislative changes stipulating that all new motor cars sold after 8 Apr. 2005 are required to have a tyre pressure monitoring system able to detect when one or more of a vehicle's tyres is significantly under-inflated. It is thought that such regulations would spread to other industrialised jurisdictions in the not so distant future.

As a result, many vehicle manufacturers have begun installing tyre pressure monitoring systems, which either indicate the exact pressure in each tyre to the driver or simply advise that one of the tyres is not correctly inflated. In the latter case, the monitoring system typically calculates an under inflated condition by comparing relative wheel angular velocities. The theory is that an under inflated tyre has a slightly smaller diameter than a correctly inflated tyre and therefore has to rotate at a higher angular velocity to cover the same distance as a correctly inflated tyre. This difference in relative angular velocity is monitored by an on-board computer that controls other functions such as anti-lock braking, traction control etc and the driver is alerted if an excessive relative difference is identified between the tyres. At the present time, these systems are the most popular because they are the least expensive to implement as the computer is already installed as part of a new vehicle's operation management system. In this regard, upon generation of a warning signal, a driver must go out and check the tyre pressure in each individual wheel to determine which tyre is under or (in some cases) over inflated.

Accordingly, what is needed is a device that allows easy and accurate inflation of a vehicle tyre to an ideal pressure whilst, at the same time, is able to readily alert the driver to an under or over inflated tyre condition.

U.S. Pat. No. 4,117,281 in the name of Eaton Corporation discloses a valve device that activates an electrical contact when the pressure within the tyre falls below a predetermined level. More specifically, the device disclosed includes a plunger acting against a spring housed within a main chamber. When the tyre pressure falls below a predetermined level, the plunger moves such that an electrical contact is made. This electrical contact, in turn, results in some form of electrical indication to the driver that the tyre pressure should be restored.

One disadvantage of this device is that it does not give any indication of over inflation, simply an under inflated or normal pressure. Also, it is noted that it is not possible to modify this device to indicate an over inflated condition. The construction is also quite complex relying on many small moveable components working together making it expensive to manufacture and potentially giving rise to functional and durability issues.

GB 1414954 in the name of The B. F. Goodrich Company discloses a valve assembly adapted for use on a motor vehicle tyre. The assembly includes first and second parallel chambers in fluid communication with the pneumatic tyre. The first chamber is used to deliver the pressurised air through a normal Schrader valve to the inside of the tyre, while the second chamber is used as the pressure relief mechanism. Upon the pressure in the pneumatic tyre reaching a predetermined level, a piston in the second chamber moves to allow the relief of excess air pressure.

When this occurs, a dust cover, disposed at the distal end of the second chamber, moves or flips up out of the way to relieve the excess pressure. In this way, a means to prevent over inflation of the tyre is provided and an over inflated condition is indicated by the dislodgement of the dust cover.

A disadvantage of this valve assembly is that it does not and cannot indicate an under inflated condition. The indication of over inflation is also not easy for a user to recognise especially at night or during adverse weather conditions and if it goes unattended, dust and water and other contaminants can enter the valve assembly and affect its performance.

Moreover, it will also be appreciated by those skilled in this art that desired tyre inflation pressures are specified when the tyre is cold. During normal use, the tyre will heat up and the pressure will increase, the degree of which is determined by many factors including length of use, ambient temperature, tyre capacity, etc. In this regard, using the valve assembly of GB1414954, when the tyre warms during normal use, the second chamber may open to relieve the excess pressure. This in turn may result in an under inflated and potentially dangerous tyre when it cools again.

WO 2000/024599 in the name of Sampson, discloses a pressure cut off valve having a movable piston disposed within a main housing. In operation, the piston moves from an open configuration where pressurised air is allowed to flow into the tyre, to a closed configuration upon reaching a desired pressure, thereby substantially restricting further inflation. An under inflation indicating means is provided in the form of a coloured band which is exposed when the piston is in the open configuration.

Whilst it is conceded that the theory behind the operation of this valve has merit, the mechanism is too complex and it is doubtful that the applicant was ever able to make a commercial embodiment that operated repeatedly. For the same reasons, such a complex system is expensive to manufacture thereby limiting its commercial appeal. Moreover, whilst not strictly relevant, it is noted that no over inflation indication is provided, nor is it possible to modify this valve to indicate over inflation only under or desired inflation pressure.

It is an object of the present invention to overcome or ameliorate at least one of the disadvantages of the prior art, or to provide a useful alternative.

It is an object of a preferred form of the present invention to provide a valve device that can indicate in all conditions both an over and under inflated tyre pressure to a user. It is a further preferred object of the present invention to provide a valve device that can indicate when the correct pressure has been reached during inflation, or alternatively prevent over inflation by restricting air flow into the tyre.

Ideally, the valve device would be simple in operation, reliable and inexpensive to manufacture.

### SUMMARY OF THE INVENTION

According to one aspect, the present invention provides a valve device for a pneumatic tyre having an upper and lower desired inflation pressure, the valve device including:

a main body having an inlet port sealingly engageable with a compressed air supply and an outlet port sealingly engageable with the pneumatic tyre;

at least one pressure sensor for sensing the pressure in the pneumatic tyre; and

an electrical indicating means operatively associated with the at least one pressure sensor for indicating to a user when the pressure in the pneumatic tyre is substantially below the lower desired inflation pressure or substantially above the upper desired inflation pressure.

In one embodiment, the electrical indicating means includes at least one illumination lamp for indicating to a user when the pressure in the pneumatic tyre is substantially below the lower desired inflation pressure or above the upper desired inflation pressure.

In one embodiment, the electrical indicating means also indicates to a user when the pressure in said tyre is between the upper and lower desired inflation pressure.

In one embodiment, the main body includes a substantially transparent portion for providing visual access to the at least one lamp.

In one embodiment, the valve device includes a movement sensor for determining if the pneumatic tyre is moving and wherein the at least one illumination lamp only illuminates when the pneumatic tyre is not moving.

In one embodiment, the at least one illumination lamp illuminates for a predetermined period of time when the pressure in the pneumatic tyre is below the lower desired inflation pressure and periodically illuminates for a predetermined period of time when the pressure in pneumatic tyre is above the upper desired inflation pressure.

In one embodiment, the at least one illumination lamp is in the form of at least one light emitting diode (LED).

In one embodiment, the valve device includes a microprocessor and a timer.

In one embodiment, the main body is substantially hollow and includes an upstream and a downstream body portion.

In one embodiment, the valve device includes a valve piston having an inlet area in fluid communication with the inlet port and an outlet area in fluid communication with the outlet port, the valve piston having one or more air transfer ducts extending between the inlet and outlet areas, the valve piston being movable between an open configuration wherein the air transfer ducts provide fluid communication between the inlet and outlet ports, and a closed configuration wherein fluid communication between the inlet and outlets ports is substantially restricted;

wherein the outlet area is larger than the inlet area such that upon inflation to at least the lower desired inflation pressure the force applied on the outlet area is greater than the force applied on the inlet area thereby moving the piston from the open configuration to the closed configuration.

In one embodiment, the valve device includes a valve seat disposed within the main body, the valve seat being sealingly engageable with a corresponding recessed valve member disposed in the valve piston.

In one embodiment, upon sealing engagement between the valve member and the valve seat, the closed configuration is defined.

In one embodiment, the valve device includes a compression spring for biasing the valve piston into the open configuration and wherein the compression spring has sufficient biasing force such that the valve piston remains in the open configuration until the pneumatic tyre substantially reaches the lower desired inflation pressure.

In one embodiment, the valve device includes a transfer tube protruding from the upstream portion, the valve piston being slidably engageable with the transfer tube.

In one embodiment, the valve device includes a wireless transmitter for sending a wireless signal to a remote receiver.

In one embodiment, the inlet port is adapted to sealingly engage with a Schrader type valve.

According to another aspect, the present invention provides a system for monitoring the pressure of a pneumatic tyre having an upper and lower desired inflation pressure, the system including:

a valve device in accordance with any one of the preceding claims; and

a wireless transmitter for sending an alert condition to a wireless receiver; and

a remote indicating means for indicating the alert condition to a user, wherein the alert condition is defined when the pressure in the pneumatic tyre is at or below the lower desired inflation pressure or at or above the upper desired inflation pressure.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

### BRIEF DESCRIPTION OF THE DRAWINGS

Preferred embodiments of the invention will now be described, by way of example only, with reference to the accompanying drawings in which:

FIG. 1 is a side view of a valve device according to a first embodiment of the invention;

FIG. 2 is a sectional side view of the valve device of FIG. 1;

FIG. 3 is a part cut away plan view of the valve device of FIG. 1, shown installed on a pneumatic tyre;

FIG. 4 is a part cut away sectional side view of the valve device of FIG. 1, shown installed on a pneumatic tyre;

FIG. 5 is a perspective view of the valve device of FIG. 1, shown installed on the pneumatic tyres of a motor vehicle;

FIG. 6 is a sectional side view of a valve device according to a second embodiment of the invention;

FIG. 7 is a sectional side view of the valve device of FIG. 6, shown in a closed configuration;

FIG. 8 is a sectional side view of the valve device of FIG. 6, shown with a deflation tool in use;

FIG. 9; is a sectional side view of the valve device of FIG. 6, shown with an over inflation tool in use; and

FIG. 10 is a side view of the valve device of FIG. 6, shown with the over inflation tool in use.

### PREFERRED EMBODIMENTS OF THE INVENTION

Exemplary embodiments of the present invention will be described in detail with reference to the annexed drawings. In the drawings, the same elements are denoted by the same reference numerals throughout. In the following description, detailed descriptions of known functions and configurations incorporated herein have been omitted for conciseness and clarity.

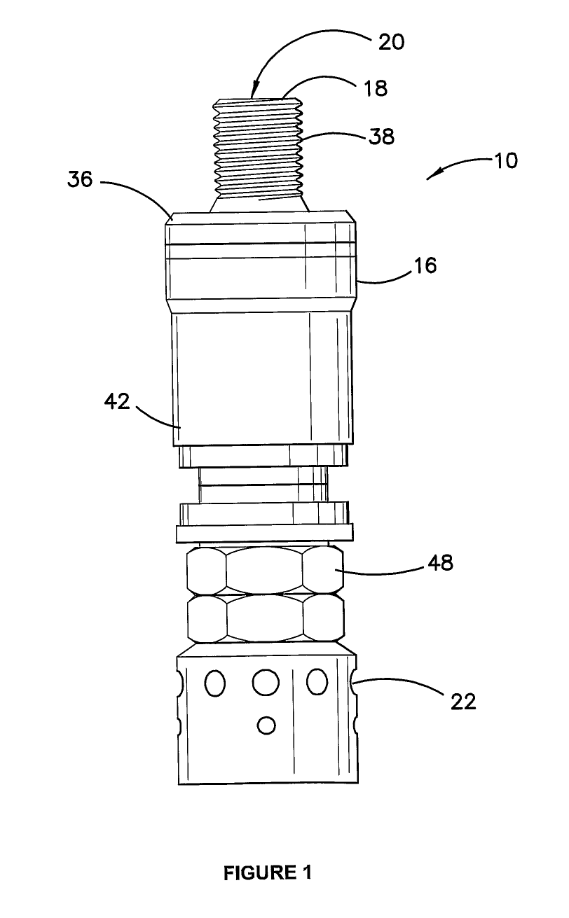

Referring to the accompanying drawings and initially to FIGS. 1 to 5, there is provided a valve device 10 for installation in the rim 14 of a motor vehicle pneumatic tyre 12.

With specific reference to FIG. 1, the valve device includes a main body 16 having an inlet port 18 adapted for sealed engagement with a compressed air supply 20, and an outlet port 22 adapted for sealed engagement with the internal pressurised volume of the pneumatic tyre 12. The compressed air supply is typically supplied by an air compressor output (not shown) having a maximum pressure rating of approximately 6.9 bar (100 psi). The inlet port 18 is also designed to receive and connect to a standard Schrader type valve (not shown) as is commonly known in the art.

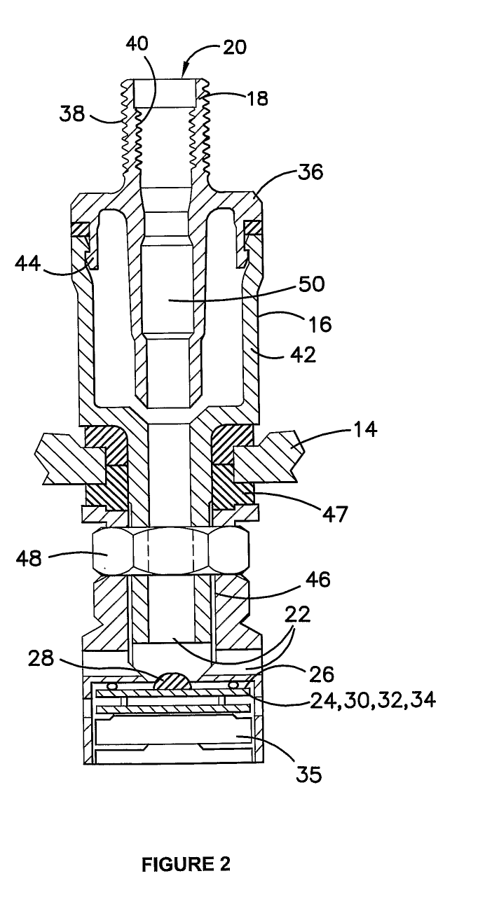

With reference to FIG. 2, a pressure sensor 24 disposed on a circuit board 26 in a lower portion of the valve 10 is provided for sensing the pressure in the pneumatic tyre. An electrical indicating means, in the form of a lamp 28 operatively associated with the pressure sensor 24, is also provided. The arrangement is that the pressure sensor cooperates with the lamp 28 to indicate to a user when the pressure in the pneumatic tyre is substantially below or above a desired inflation pressure range. It will be appreciated that in other not shown variations, more than one pressure sensor and lamp may be used.

More specifically, according to the illustrated embodiment, the pressure sensor 24 and lamp 28 are disposed on a circuit board 26. The circuit board also includes a movement sensor 30, typically in the form of an accelerometer, a timer unit 32, and a microprocessor 34; power for these components being provided by a power source 35. In this regard, it will be appreciated that in other not shown embodiments, these components may be disposed in different locations around the valve device 10 or even as part of a single integrated electronic component and not necessarily as a separate components on a single circuit board.

In another not shown variation, a supplementary or integrated wireless transmitter is provided to send a warning signal, or alternatively the sensed pressure value to a remote display, a receiver or the vehicle on-board monitoring system.

To provide visual access to the lamp when illuminated, an upstream portion 36 of the main body, and in some cases some of the internal body portions, are substantially formed from a transparent material such as a clear or slightly opaque plastics material. Alternatively, in other not shown embodiments the upstream portion 36 includes a number of perforations covered by a substantially transparent material to allow visual access to the lamp.

The valve device 10 is substantially cylindrical in overall shape and due to the design of its internal components, is generally compact relative to similar prior art valve devices.

Those skilled in this art will appreciate that in recent times, illumination technology has progress significantly and small portable lamps are now typically in the form of high intensity light emitting diodes (LEDs), which are extremely bright and consume significantly less power than normal lamps. It is for this reason that in the present invention, it is envisaged that the lamp 28 is in the form of one or more LEDs.

As mentioned earlier, the main body 16 includes an upstream portion 36 which has the inlet port 18 disposed at one end thereof. The inlet port includes an external thread 38 for engagement with a dust cap (not shown), and an internal thread 40 for engagement with the aforementioned Schrader type inlet valve (not shown), as is commonly known in the art. The main body further includes a downstream portion 42 which is connected to the upstream portion through pressed fit, threaded or clip connection 44. Defined between inlet and outlet ports, is a main chamber 50. The downstream portion includes a male thread 46 disposed about the periphery of the outlet port 22 for securing the valve device to the rim 14 of the pneumatic tyre using rubber grommets 47 and locks nuts 48. The downstream portion 42 is ideally formed from brass or aluminium as is commonly known in the art.

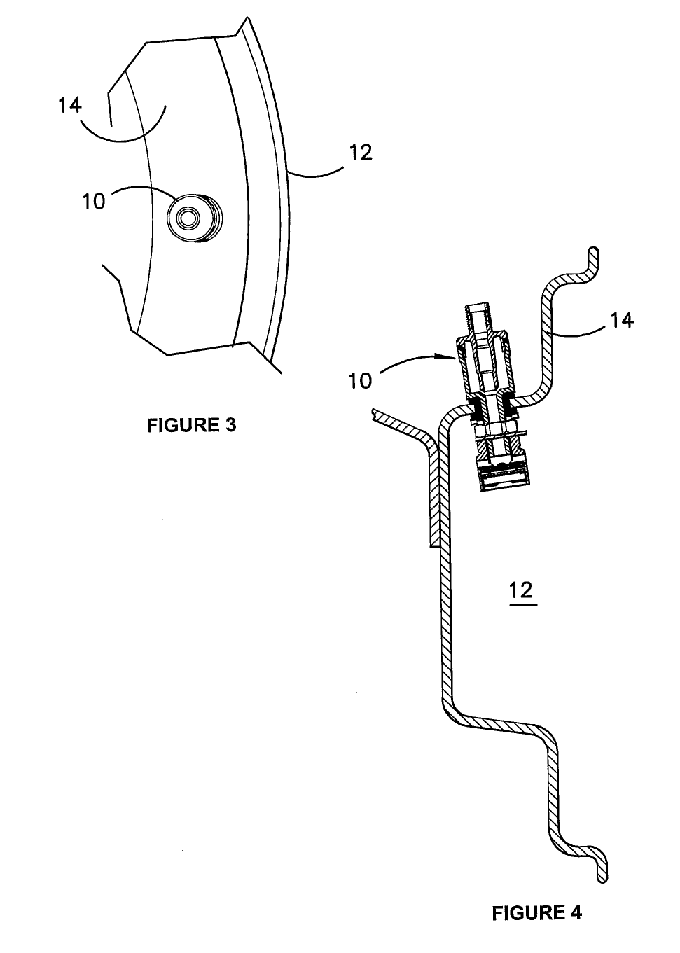

When the valve device is installed on a motor vehicle pneumatic tyre as shown in FIGS. 3 to 5, and an under inflated condition is sensed by the pressure sensor, the microprocessor 34 will instruct the lamp 28 to illuminate for a fixed period of time. However, it should be noted that the lamp will only illuminate when the movement sensor 30 has advised the microprocessor 34 that the pneumatic tyre is not moving and has recently come to a stop.

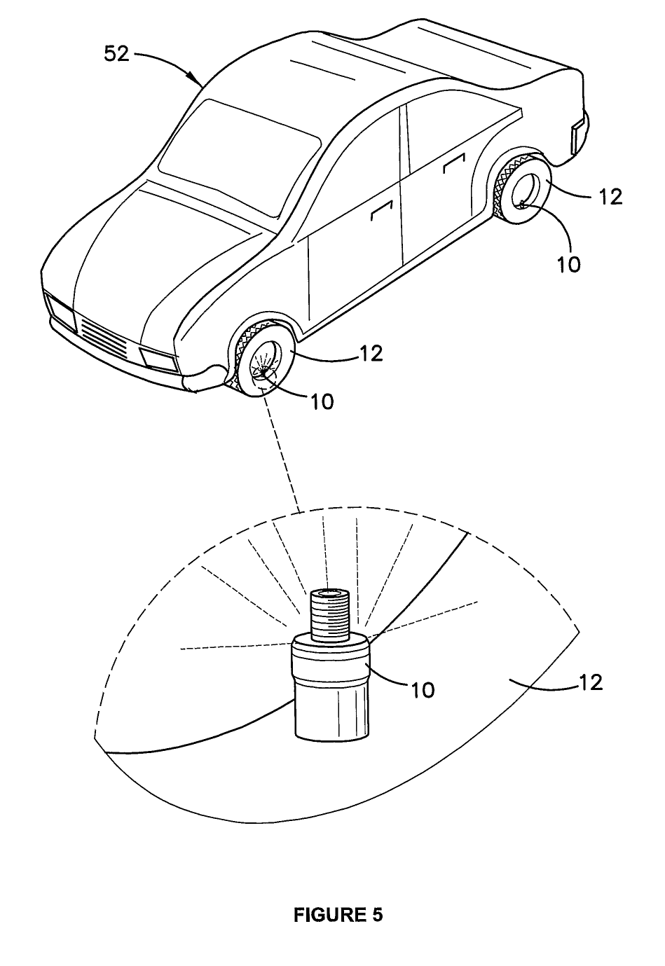

Referring to FIG. 5, in use, when the motor vehicle 52 has just stopped and the driver has exited the vehicle, the valve device 10 which has sensed an under inflated tyre, will be illuminated. When the vehicle begins to move again, the movement sensor will detect the tyre rotation and the microprocessor will instruct the lamp to turn off. Alternatively, after a fixed period of time, say two minutes, the lamp will also cease to illuminate. In this way, the power source 35 will not be drained unnecessarily. To this end, it is proposed that the power source will be sized to correspond to the average life of a pneumatic tyre in a motor vehicle application.

In the same vein, if an over inflated condition is sensed by the pressure sensor 24, the microprocessor 34 will instruct with the lamp 28 to flash on and off for a fixed period of time, again only after the movement sensor has detected that rotation of the pneumatic tyre has recently stopped. In other variations, multiple and/or different coloured lamps or flashing sequences may be used to indicate different inflation conditions.

In motor vehicles employing tyre pressure monitoring systems that indicate to the driver that one of the pneumatic tyres is either under or over inflated, the valve device of the present invention allows the driver to easily identify the offending tyre without requiring any special tools or experience. Moreover, the valve device will advantageously differentiate between the over and under inflated conditions. Since a very bright LED lamp is used, the indication to the user will be easily achieved in minimal light or a diverse weather conditions.

It will be appreciated that the over inflated and under inflated conditions are defined at different pressure levels. For example, if the predetermined ideal tyre pressure was say 2.2 bar, then the over inflation condition could be set at 2.7 bar and the under inflated condition could be set at 1.8 bar thereby to define a desired pressure range. This is because in normal use, the pressure within a motor vehicle pneumatic tyre will normally fluctuate significantly according to various factors such as ambient temperature, distance travelled, average speed, pneumatic tyre design, etc. Moreover, it is proposed that the valve device be commercially available at various selected pressure ratings to suit different applications and vehicle types. Alternatively, in a further variation, the pressure rating may be changeable via a surface mounted switching means or computer wireless control.

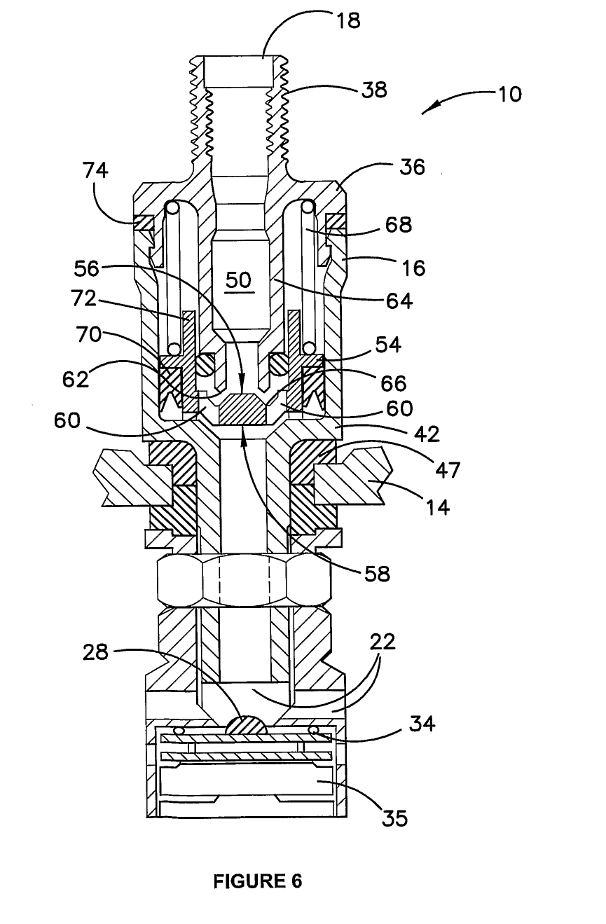

Referring now to FIGS. 6 to 10, there is described a further embodiment of the present invention.

This embodiment is similar to the previous embodiment except now the valve device 10 additionally includes a movable valve piston 54 in order to prevent over inflation of the pneumatic tyre. The piston is disposed within the main chamber 50 and includes an inlet area 56 in fluid communication with the inlet port 18 and an outlet area 58 in fluid communication with the outlet port 22. Within the valve piston are a number of air transfer ducts 60, extending between the inlet and outlet areas.

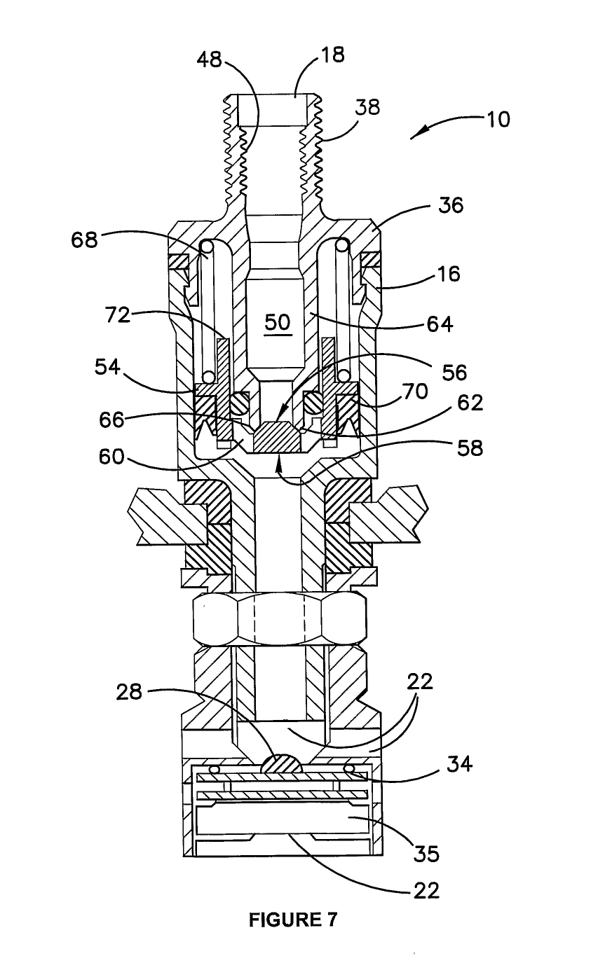

The valve piston 54 is movable between an open configuration shown in FIG. 6 and a closed configuration shown in FIG. 7. In the open configuration, the air transfer ducts 60 allow fluid communication between the inlet and outlet ports. In the closed configuration, however, fluid communication between the inlet and outlets ports is substantially blocked.

In order to achieve this, a valve seat 62 is disposed at the one end of a tube 64 protruding from the upper edge of the upstream portion 36. The valve seat is adapted to engage a complementary formed recessed valve member 66 located in the valve piston 54, thereby to provide an air seal upon contact with the valve seat and define the closed configuration. As can be appreciated, due to the shape of the recessed valve member, as the valve piston moves it will automatically locate itself onto the valve seat.

In this embodiment, the valve device also includes a coil compression spring 68 acting between the upstream portion 36 and the valve piston 54, thereby to restrict valve piston 54 movement until a preselected inflation pressure is achieved. A number of seals 70 are also provided and are positioned about the valve device for sealing engagement between moving components.

The arrangement is such that upon reaching the desired lower inflation pressure within the pneumatic tyre, a force is applied to the outlet area 58 to move the valve piston towards the inlet port 18. Those skilled in this art will appreciate that the reason this occurs is because the outlet area 58 is larger than the inlet area 56 such that upon reaching the desired inflation pressure, the force applied on the outlet area is greater than the force applied on the inlet area by the compressed air supply and spring force.

In order to alert a user of when the pneumatic tyre is under inflated, the electrical indicating means of the first embodiment is provided and, for the sake of brevity, its operation will not be repeated here. However, it will be noted that the lamp illumination may be obscured by the piston 54. For this reason, in this embodiment the lamp 28 may be relocated accordingly so that it can be observed through the transparent upstream portion of the main body. Alternatively the piston may also be formed from a substantially transparent material.

As mentioned above, the valve device 10 is installed on a pneumatic tyre rim 14 and a Schrader inlet valve (not shown) is disposed in the inlet port. Initially, when the tyre is under inflated, the valve device 10 will be in an open configuration due to the force provided by the compression coil spring 68. To inflate, the high-pressure air supply is delivered to the inlet port 18 to the inside of the pneumatic tyre through air transfer ducts 60 and outlet port 22.

The high-pressure air continues until the desired inflation pressure, say 2.2 bar is reached. At this point the force applied to the outlet area 58—due to the tyre inflation pressure—begins to be greater than the force applied by the compression spring 68 and the high-pressure air supply on the inlet area 56. Accordingly, the valve piston 54 begins to move towards the inlet port 18.

Upon contact between the valve member 66 and valve seat 62, the path to the air transfer ducts 60 becomes blocked and no more high pressure air can be delivered to the outlet port. It should be understood that due to the known force applied by coil compression spring 68, the valve piston will not begin its initial movement unless the desired inflation pressure is reached irrespective of the magnitude of high pressure air supply.

Upon valve piston movement away from the open configuration, or alternatively upon contact between the valve member and valve seat, the lamp 28 will de-energise and the user will be alerted that the pneumatic tyre has reached the ideal inflation pressure. Advantageously, even if the user ignores the lamp de-energising, additional high-pressure air cannot be delivered into the pneumatic tyre because of the piston will soon reach the closed configuration. Therefore an over inflation of the tyre cannot occur, however, the internal pressure may still rise due to the previously mentioned road use fluctuations.

At the end of the inflation process, the high-pressure air supply is removed from the valve device 10 and the valve piston 54 remains in the closed configuration. If, however, the pressure in the pneumatic tyre begins to fall below the desired under inflation pressure, the force provided by the compression spring 68 will be greater that the force provided by the pneumatic tyre pressure and the valve piston will move away from the closed configuration towards the open configuration. Of course, under these circumstances the lamp will again energise to alert the user.

This embodiment of the valve device 10 may be advantageously rated at an ideal inflation pressure for the particular application by increasing or decreasing the inlet, outlet areas and altering the compression coil spring properties. In this way, heavier or lighter motor vehicles or even motorcycles can also be accommodated.

In a further variation of this embodiment, the movement of the piston may energise a supplemental electrical contact which in turn will send a further electrical signal to the microprocessor 34. In yet a further variation of either of the aforementioned embodiments, the lamp 28 may be integral with a light ring 72 fixed to the valve piston 54. Alternatively, the lamp may be integral with an O-ring seal 74, which will also be visible through the transparent upstream portion 36.

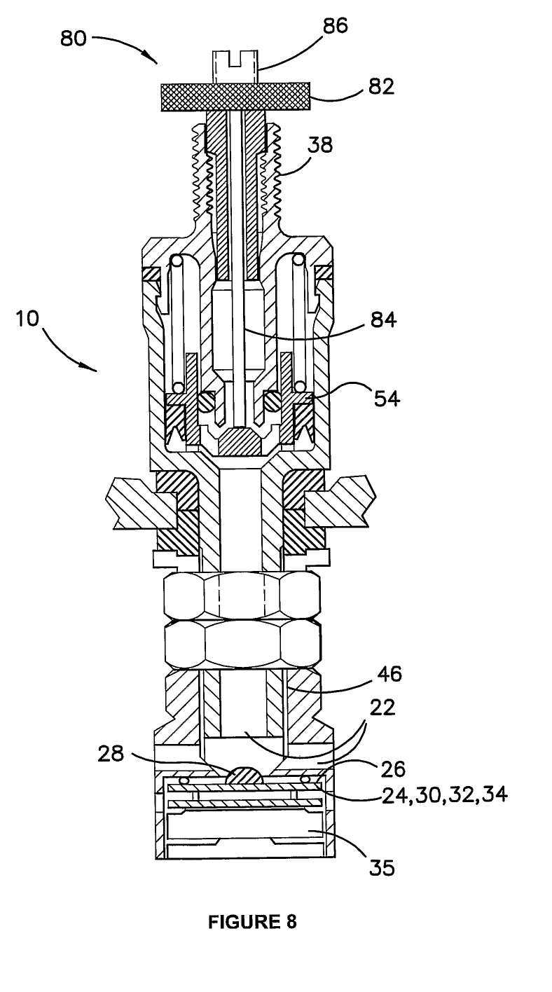

Referring now to FIG. 8, it should be noted that when the valve device 10 of this embodiment is fitted to a pneumatic tyre and it is inflated to the ideal pressure, the tyre will not deflate even when the Schrader valve is removed. Therefore, to deflate the tyre it is necessary to remove the Schrader valve and manually push the valve piston 54 towards the open configuration to allow the air to escape. After the pressure has dropped by about 20 percent, the valve piston will move to the open configuration because of the force provided by coil compression spring, and the tyre will deflate.

To this end, there is provided a deflation tool 80, which is used to push the valve piston away from the valve seat and into the open configuration after the removal of the Schrader valve. The deflation tool 80 includes a handle 82 and an elongate plunger 84. On the opposite of the handle 82, there is a Schrader valve removal attachment 86.

A quick and easy means of opening up the valve deice 10 while the pneumatic tyre is fully inflated is thereby provided, with only one tool required to remove the Schrader valve and deflate the tyre. As soon as a little air has escaped the deflation tool 80 can be removed and the Schrader valve re-installed to prevent further air from escaping. The pneumatic tyre can then be inflated to the desired pressure as described above. It should be understood that tyre technicians would typically only use the deflation tool if they need to deflate the tyre before removing it from the rim.

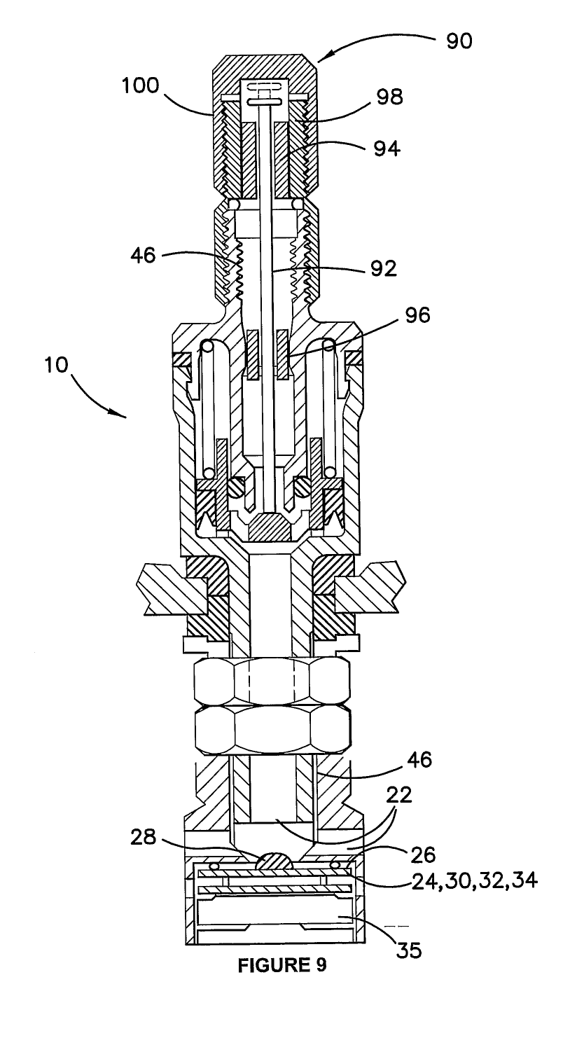

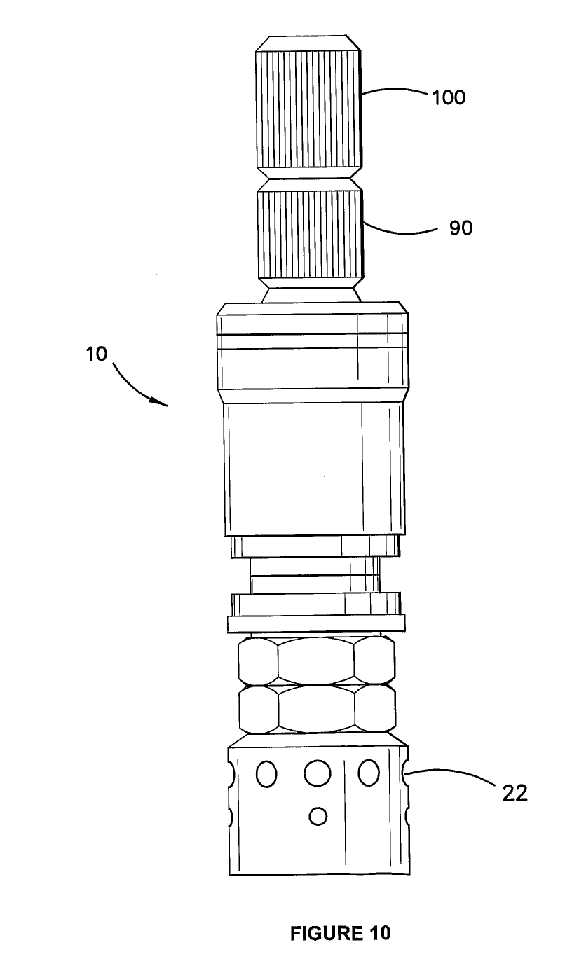

Similarly, when a vehicle has to carry heavy loads it may be necessary to inflate pneumatic tyres to a higher pressure than is required for normal driving conditions. Accordingly, as shown in FIGS. 9 and 10, there is provided an over inflation tool 90.

The over inflation tool 90 includes a plunger 92 movably mounted to an upper and lower axial guide bearings 94, 96. The upper axial guide bearing 94 is, in turn, mounted to a body portion 98, which is threadingly mounted to the valve device 10. A dust cap 100 is further provided to seal the valve device.

To install, the Schrader valve is first removed and the over inflation tool 90 is fitted to the dust cap thread 38. Subsequent to this installation, it will be possible to move the valve device 10 to the open configuration by pressing on the top of the plunger 92. Therefore, when a normal high pressure hose is attached to the top of the over inflation tool it will depress the plunger just like it depresses the pin projecting from a Schrader type valve. This will hold the valve open and permit inflation to any desired pressure.

It will be appreciated that the above described embodiments disclose a valve device that allows easy and accurate inflation of a pneumatic tyre, without the need for a pressure gauge. They also provide a means to easily determine both over and under inflation of a pneumatic tyre in all conditions. The components are advantageously easy to manufacture and are made from common materials resulting in commercial embodiments being relatively inexpensive.

Advantageously, the valve device 10 can communicate the under or over inflated condition of the tyres to a vehicle on-board pressure monitoring system. Moreover, since the under and over inflated condition is indicated by an lamp, individual pressure monitoring by the on board system is not required as the user can simply ascertain which tyre is under or over inflated by visual inspection. In this way, a generally less sophisticated and therefore less expensive on board system is required.

In one variation of the present invention, the lamp 28 may also periodically illuminate when the pneumatic tyre has not moved for an extended period and an under or over inflated condition is detected so as to alert the user while the vehicle is not moving. In yet a further variation, the motor vehicle door release activation or alarm system activation is sensed or communicated to the microprocessor 34 via a supplemental receiver so that an under or over inflated condition can be indicated to a user upon approach or entry to the vehicle. In yet a further variation, an under or over inflated condition is indicated to a user via the door or alarm activation control.

Although the invention has been described with reference to specific examples, it will be appreciated by those skilled in the art that the invention may be embodied in many other forms.

1. A valve device for a pneumatic tyre having an upper and lower desired inflation pressure, said valve device including:
a main body having an inlet port sealingly engageable with a compressed air supply and an outlet port sealingly engageable with said pneumatic tyre;
at least one pressure sensor for sensing the pressure in said pneumatic tyre;
a microprocessor disposed in a lower portion of said main body; and
at least one lamp operatively associated with said at least one pressure sensor and said microprocessor such that upon said pressure in said pneumatic tyre being substantially above or below said upper or lower desired inflation pressures respectively, said microprocessor instructs said at least one lamp to illuminate.

2. A valve device according to claim 1, wherein said at least one lamp is disposed in a lower portion of said main body.

3. A valve device according to claim 1, wherein said main body includes a substantially transparent portion for providing visual access to said at least one lamp.

4. A valve device according to claim 1 including a movement sensor for determining if said pneumatic tyre is moving and wherein said at least one illumination lamp only illuminates when said pneumatic tyre is not moving.

5. A valve device according to claim 1, wherein said at least one lamp illuminates for a predetermined period of time when said pressure in said pneumatic tyre or below said lower desired inflation pressure and periodically illuminates for a predetermined period of time when said pressure in pneumatic tyre or above said upper desired inflation pressure.

6. A valve device according to claim 1, wherein said at least one lamp is in the form of at least one light emitting diode (LED).

7. A valve device according to claim 1 including a timer.

8. A valve device according to claim 1, wherein said main body is substantially hollow and includes an upstream and a downstream body portion.

9. A valve device according claim 1 including a valve piston having an inlet area in fluid communication with said inlet port and an outlet area in fluid communication with said outlet port, said valve piston having one or more air transfer ducts extending between said inlet and outlet areas,
said valve piston being movable between an open configuration wherein said air transfer ducts provide fluid communication between said inlet and outlet ports, and a closed configuration wherein fluid communication between said inlet and outlets ports is substantially restricted;
wherein said outlet area is larger than said inlet area such that upon inflation to at least said lower desired inflation pressure the force applied on said outlet area is greater than the force applied on the inlet area thereby moving the piston from said open configuration to said closed configuration.

10. A valve device according to claim 1 including a valve seat disposed within said main body, said valve seat being sealingly engageable with a corresponding recessed valve member disposed in said valve piston.

11. A valve device according to claim 10, wherein upon sealing engagement between said valve member and said valve seat, said closed configuration is defined.

12. A valve device according to claim 9 including a compression spring for biasing said valve piston into said open configuration and wherein said compression spring has sufficient biasing force such that said valve piston remains in said open configuration until said pneumatic tyre substantially reaches said lower desired inflation pressure.

13. A valve device according to claim 12 including a transfer tube protruding from said upstream portion, said valve piston being slidably engageable with said transfer tube.

14. A valve device according to claim 1 including a wireless transmitter for sending a wireless signal to a remote receiver.

15. A valve device according to claim 1, wherein said inlet port is adapted to sealingly engage with a Schrader type valve.

16. A system for monitoring the pressure of a pneumatic tyre having an upper and lower desired inflation pressure, said system including:
a valve device in accordance with; and
a wireless transmitter for sending an alert condition to a wireless receiver; and
a remote indicating means for indicating said alert condition to a user, wherein said alert condition is defined when said pressure in said pneumatic tyre is at or below said lower desired inflation pressure or at or above said upper desired inflation pressure.
